(19) United States
(12) Patent Application Publication
(10) Pub. No.: US 2025/0115211 A1
(43) Pub. Date: Apr. 10, 2025

(54) System and Methods for Theft Prevention of a Vehicle Component

(71) Applicant: CATrak Technologies, Inc., San Diego, CA (US)

(72) Inventors: Mark Steven Richardi, Huntington Beach, CA (US); John Rollins, Palo Alto, CA (US); Natasha Peterson, Yucca Valley, CA (US); Gregory Duff Bracy, Simi Valley, CA (US)

(73) Assignee: CATrak Technologies, Inc., San Diego, CA (US)

(21) Appl. No.: 18/988,649

(22) Filed: Dec. 19, 2024

Related U.S. Application Data
(63) Continuation-in-part of application No. 18/013,345, filed on Dec. 28, 2022, now Pat. No. 12,211,367.
(60) Provisional application No. 63/228,392, filed on Aug. 2, 2021.

(51) Int. Cl. B60R 25/102; G08B 25/10

(52) U.S. Cl. CPC B60R 25/102; G08B 25/10

(57) ABSTRACT

Systems and methods for monitoring for theft of a vehicle component (e.g., a catalytic converter) or another item is provided herein. A monitoring device can be communicatively coupled with a GPS locator and a wireless transceiver such that a location signal can be generated and sent upon certain conditions being met. Preferably, the monitoring device is connected to an external power source and causes the location signal to be generated and sent when there is an interruption in power received from the external power source.

### CROSS-REFERENCE TO RELATED APPLICATIONS

This application is a continuation-in-part application of U.S. patent application Ser. No. 18/013,345, filed on Dec. 28, 2022, which itself is a national phase application of PCT patent application no. PCT/US2022/039223, filed on Aug. 2, 2022, which claims the benefit of priority to U.S. provisional patent application No. 63/228,392, filed Aug. 2, 2021. which in incorporated by reference in its entirety. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### TECHNICAL FIELD

The technical field is directed to a system and a device for theft prevention and/or recovery of a component of a vehicle or other item.

### BACKGROUND

The following description includes information that may be useful in understanding the present invention. It is not an admission that any of the information provided herein is prior art or relevant to the presently claimed invention, or that any publication specifically or implicitly referenced is prior art.

Global theft of catalytic converters has reached epidemic proportions. Catalytic converters can be stolen from a vehicle in under two minutes using easily accessible tools. Aside from inconvenience, enormous monetary and efficiency losses are being borne by insurance companies, fleet operators, or those owning or operating a vehicle whose catalytic converter is stolen.

Catalytic converters have been mandated by governments for all gasoline cars and trucks in the United States since 1975. Catalytic converters are a mandatory part of a vehicle's exhaust system that reduces toxic emissions and pollutants. For example, catalytic converters contain many precious metals such as Rhodium, Platinum and Palladium, which are used to eliminate nitrogen oxide, carbon monoxide emissions or hydrocarbon emissions from unburnt fuel.

As the value of the precious metals continue to rise, U.S. and global theft rates have grown exponentially. Thefts of catalytic converters in commercial and consumer vehicles reached an all-time high in 2020, with many large cities reporting increases in left more than twenty times the number reported in 2019. In some areas, thefts have grown exponentially with thefts of catalytic converters on the west coast of the United States increasing more than 400% and more than 700% in Quebec, Canada year over year.

The most common solutions to try and prevent catalytic converter theft are cages, plates and other physical barriers. However, most physical barriers are easily cut and dismantled with saws used by thieves, and therefore offer only minimal protection. Such barriers can sometimes require professional installation raising the cost to the vehicle's owner.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for improved theft deterrent and tracking devices for catalytic converters.

### SUMMARY OF THE INVENTION

In one aspect, a tethered device for prevention and recovery of a vehicle component (e.g., a catalytic converter) is provided herein. The tethered device comprises a housing having an exterior surface and defining an interior cavity. The tethered device further comprises an electronic component disposed within the interior cavity. The tethered device further comprises a plurality of spacers extending from the exterior surface and configured to be adjacent to the vehicle component. The plurality of spacers defines a channel configured to promote airflow between the tethered device and the vehicle component thereby minimizing heat transfer between the tethered device and the vehicle component.

In another aspect, a system for prevention and recovery of a vehicle component of a vehicle is also provided herein. The system comprises a tethered device comprising a GPS locator. The tethered device is configured to be fixedly coupled to the vehicle component. The system further comprises a vehicle device comprising a siren. The vehicle device is configured to be coupled to the vehicle. The system further comprises a communication cable coupled to the tethered device and the vehicle device for providing a communication signal between the tethered device and the vehicle device. The system is configured to cause the GPS locator to generate a location signal when there is an interruption in the communication signal through the communication cable. The system is configured to cause the siren to activate when there is an interruption in the communication signal through the communication cable.

In another aspect, a system for preventing theft of and/or locating a stolen or missing item is disclosed herein. Preferred systems comprise a monitoring device that is communicatively coupled to other components in the system. The systems may further include a GPS locator coupled with the monitoring device which may include a wireless transceiver or be communicatively coupled with a transmitter or transceiver such that the GPS locator can transmit a location signal to a remote server. The monitoring device is preferred powered by a power source, which may also power the GPS locator. Alternatively or additionally, one or both of the monitoring device and GPS locator may comprise an additional power source such as a battery.

Contemplated systems are preferably configured to cause the GPS locator to generate a location signal when there is a drop in voltage from the power source to the monitoring device or the GPS locator. This signal can then be transmitted to a remote server via the wireless transceiver, for example.

It is further contemplated that the monitoring device may be communicatively coupled to a sensor, which can detect potential theft of an item. In some embodiments, the sensor may be connected to the item. It is preferred in such embodiments that the monitoring device can receive a signal from the sensor and cause the wireless transceiver to transmit the location signal to the remote server when the signal is received from the sensor or communication between the monitoring device and the sensor is interrupted.

In still further embodiments, the system may further include a siren or other noise maker that is communicatively coupled with the monitoring device. In such embodiments, the monitoring device may cause the siren to activate when there is the interruption in power from the power source to the first device or the GPS locator.

In some embodiments, the system is integrated into a motor vehicle. In such embodiments, the monitoring device can be connected to a battery of the motor vehicle which can act as the power source for the system. Also, when the system is integrated into a motor vehicle, the monitoring device may be configured to detect potential tampering with or theft of a catalytic converter of the vehicle.

Preferred systems may create a circuit using a portion of the vehicle's chassis. In one embodiment, the circuit comprises the monitoring device connected to a battery or other power source of the vehicle. As discussed above, the monitoring device may be communicatively coupled to a GPS locator, a wireless transmitter/transceiver, and/or a siren. The circuit may also be coupled to two points on an exhaust pipe of the vehicle. In preferred embodiment, there is a connection to a rear of the exhaust pipe and a connection to the catalytic converter of the vehicle to thereby provide a current return path for the circuit. If the exhaust pipe is cut to remove the catalytic converter, this interruption is detected by the monitoring device which then causes the GPS locator to generate a location signal and the signal is then transmitted to the remote server via the transmitter/transceiver.

Rather than be connected to the catalytic converter directly, it is contemplated that the connection is to a sensor disposed at a base of an oxygen sensor of the catalytic converter. This sensor preferably monitors for tampering with the catalytic converter. In some embodiments, the monitoring device system is configured to cause the wireless transceiver to transmit the location signal to a remote server and/or cause the siren to activate when a signal is received from the sensor indicating tampering with the catalytic converter.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a perspective view illustrating a non-limiting embodiment of a tethered device comprising a housing.

FIG. 2 is an exploded view illustrating a non-limiting embodiment of the housing of FIG. 1.

FIG. 3 is a cross-sectional view illustrating a non-limiting embodiment of the housing of FIG. 1.

FIG. 4 is a perspective view illustrating a non-limiting embodiment of the tethered device of FIG. 1 coupled to a vehicle component.

FIG. 5 is a cross-sectional view illustrating a non-limiting embodiment of the tethered device coupled to the vehicle component of FIG. 4.

FIG. 6 is a cross-sectional view illustrating a non-limiting embodiment of the tethered device of FIG. 1 comprising an electronic component.

FIG. 7 is a cross-sectional view illustrating a non-limiting embodiment of the tethered device of FIG. 1 comprising another electronic component.

FIG. 8 is a top view illustrating a non-limiting embodiment of the tethered device of FIG. 1.

FIG. 9 is a schematic view illustrating a non-limiting embodiment of the tethered device of FIG. 1 coupled to a vehicle component.

FIG. 10A is a front view illustrating a non-limiting embodiment of a siren.

FIG. 10B is a rear view illustrating a non-limiting embodiment of the siren of FIG. 10A.

FIG. 11 is a front view illustrating a non-limiting embodiment of a phone showing an application for the tethered device of FIG. 1.

FIGS. 12A and 12B are exploded views illustrating non-limiting embodiments of a tethered device.

FIGS. 13A, 13B, and 13C are perspective views partially in phantom illustrating non-limiting embodiments of the tethered device of FIGS. 12A and 12B.

FIG. 14 is a perspective view illustrating a non-limiting embodiment of an insert, a plurality of spacers, and a bracket of FIGS. 12A and 12B.

FIG. 15 is a perspective view illustrating a non-limiting embodiment of a vehicle device.

FIG. 16 is a photograph illustrating a non-limiting embodiment of a system comprising a tethered device and a vehicle device.

FIG. 17 is a diagram illustrating a non-limiting embodiment of various components of a system for monitoring a status of a component in a vehicle.

FIG. 18 is a diagram of a non-limiting embodiment of a circuit for a system for monitoring a status of a component in a vehicle.

FIG. 19 is an illustration of one example of how connections of the circuit of FIG. 18 may be connected to an exhaust pipe and catalytic converter in a vehicle.

FIG. 20 is an exemplary illustration of the vehicle device 146.

FIG. 21 is a non-limiting illustration of the secondary harness 212.

FIG. 22 is another non-limiting illustration of the harness, wherein the harness may be configured to connect a monitoring device 202 to a GPS locator 204, as well as to an exhaust pipe 250 and a sensor 206 monitoring the catalytic converter, among other uses described herein.

FIG. 23 is a non-limiting illustration of a kit including the monitoring device and two harnesses.

### DESCRIPTION OF THE INVENTION

The inventive subject matter provides apparatus, systems and methods for catalytic converter theft prevention and recovery. In some contemplated embodiments, a device can be affixed or otherwise attached to a vehicle's catalytic converter to monitor for potential theft. Advantageously, and compared with prior art trackers, the contemplated devices herein can be installed in minutes to the top, bottom, or side of a catalytic converter using the bonding agent and/or straps to hold the device in place.

Contemplated devices comprise an outer housing that at least partially defines an interior compartment. Within the interior compartment, various electronics can be housed that allow the devices to function as described herein. It is critical that this compartment is thermally insulated from the substantial amount of heat from the catalytic converter when operating. It was found that average catalytic converter surface area temperatures were between 415 degrees Fahrenheit and 455 degrees Fahrenheit, with temperatures as high as 2,000 degrees Fahrenheit on a faulty, clogged catalytic converter. Typical plastic PCB boards, components, batteries, and housings are rated at less than 200 degrees Fahrenheit. Thus, anything above this rated temperature threshold for short periods could prematurely affect the technology and rapidly deteriorate the housing and internal components.

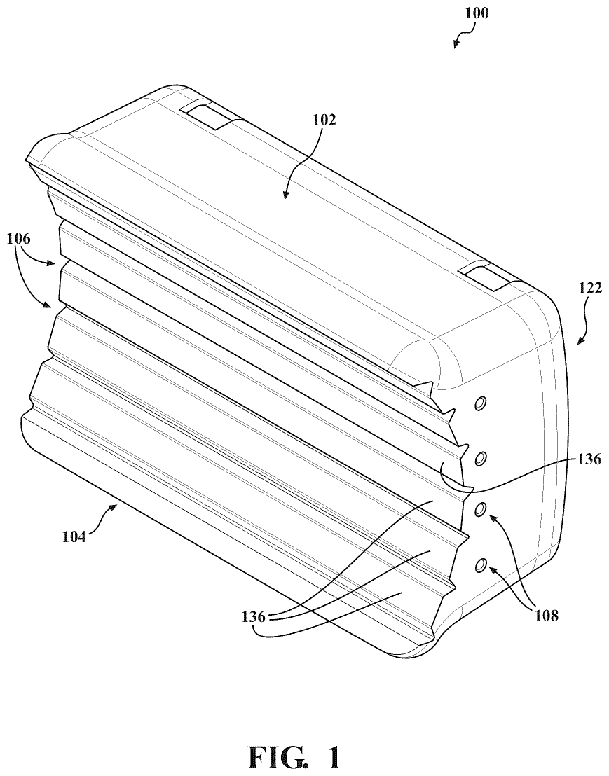

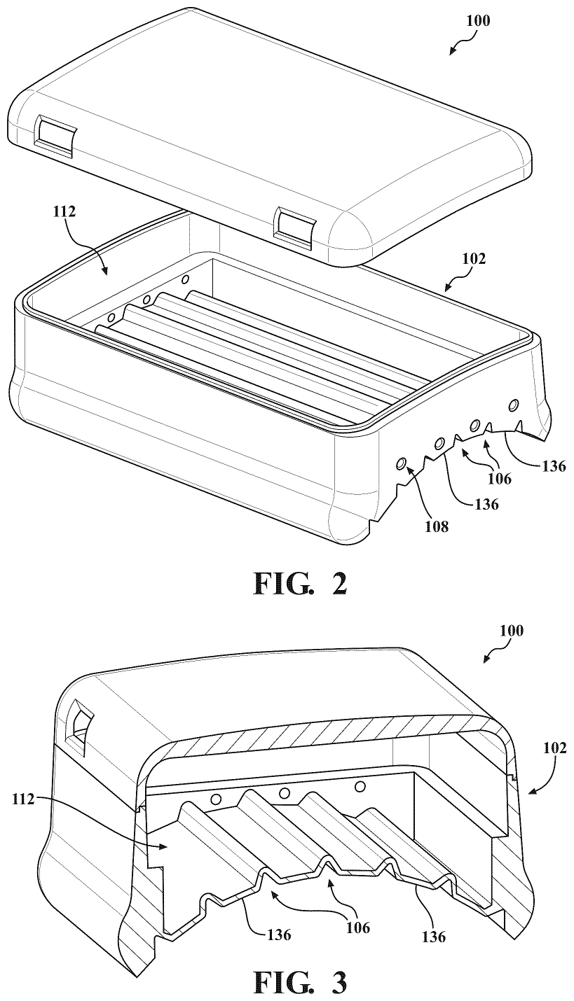

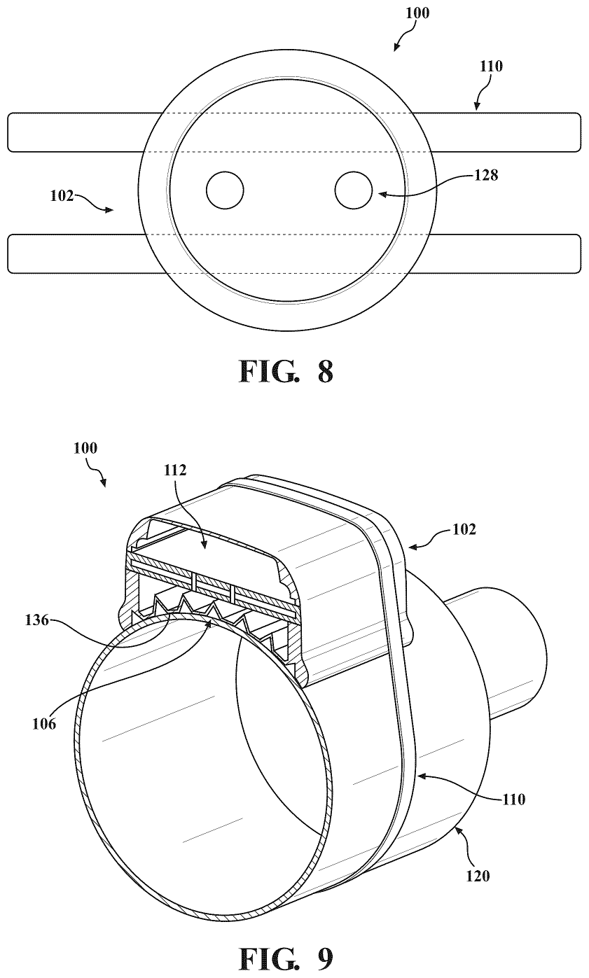

As shown in FIGS. 1-8, the device 100 may comprise an outer housing or casing 102. The outer housing 102 can comprise a first side 104 having a curved surface with a plurality of channels 106 disposed parallel along the first side 104 from a first end to a second end. These channels 106 can be used to allow the first side 104 to be flexible, as well as promote airflow to facilitate heat transfer from the device 100. The flexibility of the first side 104 permits the device 100 to attach to catalytic converters 120 having different form factors. This is critical as there are a number of different sizes and form factors for catalytic converters 120 including cylindrical and ovular shaped converters having a range of diameters and with lengths mostly ranging between six to twenty-three inches. By ensuring the first side 104 attaching to the catalytic converter 120 is flexible, the same device 100 could be attached to various form factors of catalytic converters 120.

In various embodiments, the outer housing 102 is composed of a preformed aerogel or other insulating material capable of both withstanding the heat produced by the catalytic converter 120 (greater than 500° F.) and preventing excessive temperatures from reaching the enclosed cavity 112. In some embodiments, the aerogel is utilized due to its extremely low thermal conductivity of 0.03 W/(m·K) in atmospheric pressure. Generally speaking, aerogels are dry, nanoporous, nanostructured materials that exhibit a diverse array of extreme and valuable materials properties, e.g. low density, ultralow thermal conductivity, high density-normalized strength and stiffness, and high specific internal surface area, amongst others. The term aerogel may refer to a substance having a certain material composition that exhibits a particular geometry. Suitable aerogel material compositions may include, for example, silica, metal and metalloid oxides, metal chalcogenides, metals and metalloids, organic polymers, biopolymers, amorphous carbon, graphitic carbon, diamond, and discrete nanoscale objects such as carbon nanotubes, boron nitride nanotubes, viruses, semiconducting quantum dots, graphene, two-dimensional boron nitride, or combinations thereof.

Additionally, a number of aerogel nanocomposite configurations may be prepared, for instance, materials that integrate organic polymers and silica into a single network (e.g., ormosils, organically modified silica/silicate materials, etc.), materials in which two or more separate networks of different composition are interpenetrating (e.g., a metal oxide network interpenetrated with a resorcinol-formaldehyde polymer network), core-shell nanocomposites in which a polymer conformally coats the interior contour surfaces of an oxide network (e.g. x-aerogels, cross-linked aerogels, etc.), aerogels in which nanoparticles of a varying composition are dispersed (e.g. metal-nanoparticle-doped carbon aerogels, gold-nanoparticle-doped silica aerogels), and more. As provided herein, aerogel materials may be considered as any solid-phase material that is primarily mesoporous (i.e., contains pores between 2-50 nm in diameter), comprising at least a 50% void space by volume in which the solid-phase component comprises a 3D nanostructured solid network. Materials with pore sizes outside of 2-50 nm, e.g. <1-100 nm, <1 nm to less than about one micron, are also often considered aerogels. Accordingly, any material that meets this description may be considered as an aerogel material.

Some other contemplated materials include, for example, polyamide-imide (PAI), polytetrafluoroethylene (PTFE), perfluoroalkoxy (PFA), and DuPont™ Vespel® Polyimide. It is to be appreciated that any material may be utilized so long as the material is compatible with the temperature of the catalytic converter 120 and exhibits low thermal conductivity.

It is contemplated that the device 100 can include one or more holes 108 in the housing 102 to permit additional airflow and help to exhaust heat from/cool the interior of the housing 102. In certain embodiments, the device 100 comprises four holes 108 arranged laterally relative to each other and extending along the housing 102. In these and other embodiments, the holes 108 may have a circular cross section (see FIGS. 1-6). In other embodiments, the device 100 comprises two hole 108 arranged longitudinally relative to each other and extending along the housing 102. In these and other embodiments, the holes 108 may have an ovular cross section (see FIG. 7).

The outer housing 102 may further comprise a second side 122 opposite the first side 104. The device 100 may further comprise a cap 124 coupled to the second side 122. An enclosed cavity 112 may be defined between the outer housing 102 and the cap 124. The enclosed cavity 112 may be adapted to contain an electrical device 126. One or more risers 128 may extend from the outer housing 102 into the enclosed cavity 112. The electrical device 126 may be supported by the risers 128 to minimize movement of the electrical device 126 within the enclosed cavity 112 and to reduce contact between the electrical device 126 and the outer housing 102 for minimizing thermal transmittance from the catalytic converter 120 to the electrical device 126. In various embodiments, the cap 124 and the risers 128 are composed of the same material used to form the outer housing 102. However, it is to be appreciated that the cap 124 and the risers 128 may be composed of other materials.

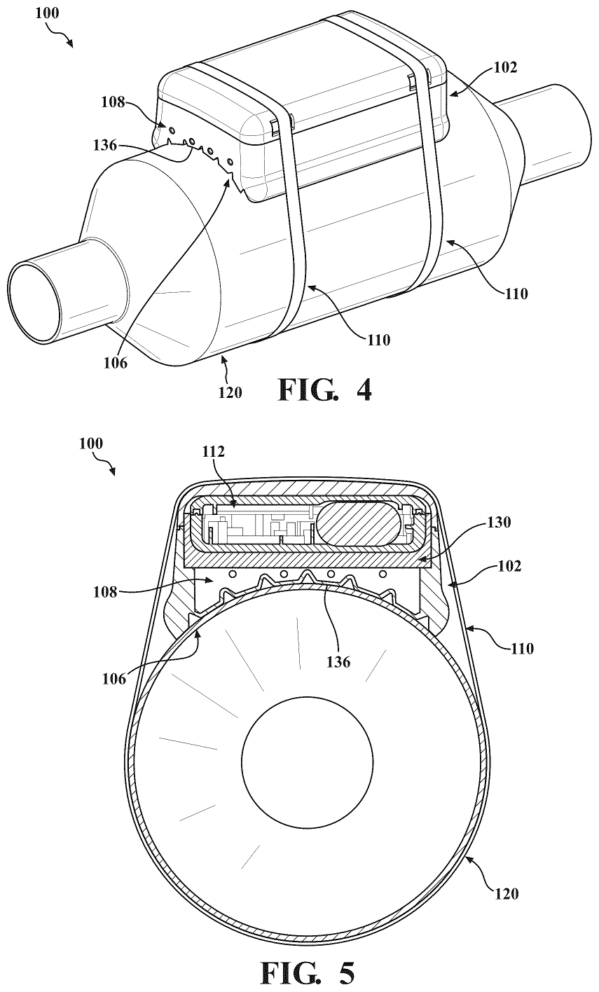

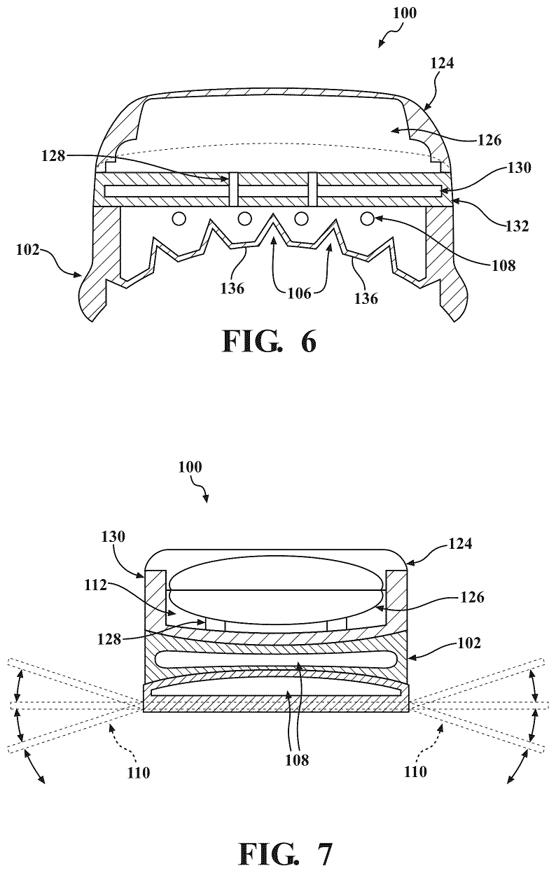

In some embodiments, with particular reference to FIGS. 4-7, the device 100 further comprises a base 130 disposed between the outer housing 102 and the cap 124 and adapted to define the enclosed cavity 112 therebetween. The base 130 may be adapted to support the electrical device 126 and further isolate the electrical device 126 from the catalytic converter 120. Likewise, with particular reference to FIG. 6, the device 100 further comprises an insulation layer 132 disposed between the outer housing 102 and the base 130 to further isolate the electrical device 126 from the catalytic converter 120. In various embodiments, the base 130 and the insulation layer 132 are composed of the same material used to form the outer housing 102. However, it is to be appreciated that the cap 124 and the risers 128 may be composed of other materials.

To attach the device 100 to the catalytic converter, an adhesive may be applied to the mounting surface of the catalytic converter 120 and/or first side 104 of the device 100. In an exemplary embodiment, a high heat silicone sealant is used to adhere the device 100 to the catalytic converter 120. Where desired, it is contemplated that stainless steel or similar rigid metal or other commercially suitable straps 110 could be used to further hold the device 100 in place on the catalytic converter 120, such as shown in FIGS. 4 and 5. The straps 110 can also be used to reduce to a considerable extent the stress on the silicone bonding agent.

Thus, to install the device 100 on the catalytic converter 120, it is contemplated that the silicone bonding agent can be applied to the device 100 and/or the catalytic converter 120 and the device 100 can then be pressed against the catalytic converter 120 until the bonding agent cures. Then the straps 110 can be tied around the catalytic converter 120 and device 100, and be tied together using a clamping tool, for example.

In other embodiments, the device 100 does not include the straps 110 and the adhesive described above couples the first side 104 of device 100 to the catalytic converted 120. The adhesive may be adapted to disassociate from at least one of the device 100 or the catalytic converter 120 when the surface of the catalytic converter 120 reaches a pre-determined temperature, such as 700 degrees Fahrenheit. This disassociation at the pre-determined temperature may be used to provide an indication that the catalytic converted 120 is failing. The device 100 may remain tethered to, but still disassociated from, the catalytic converted 120 or the vehicle including the catalytic converted 120 to prevent an inadvertent collision of the device 100 with another vehicle.

The enclosed cavity 112 of the outer housing 102 can house various electronics including, for example, a micro or other PCB, which is communicatively coupled with an accelerometer, an alarm, a battery and a GPS transceiver. This insulated cavity 112 advantageously protects the electronics from the high temperature of the catalytic converter 120 and maintains temperatures within their acceptable tolerances. Non-limiting examples of suitable electronic devices 126 include trackers, such as those commercially available from Xirgo Global under the tradename of Sensata, such as XT4500 and XG4600, from Montage under the tradename Dagger, and from Micron under the tradename Pod. The temperature gradient across the device 100 is shown in FIG. 9, wherein the catalytic converter 120 can be more than 500° F., while the interior cavity of the device 100 remains below 200° F.

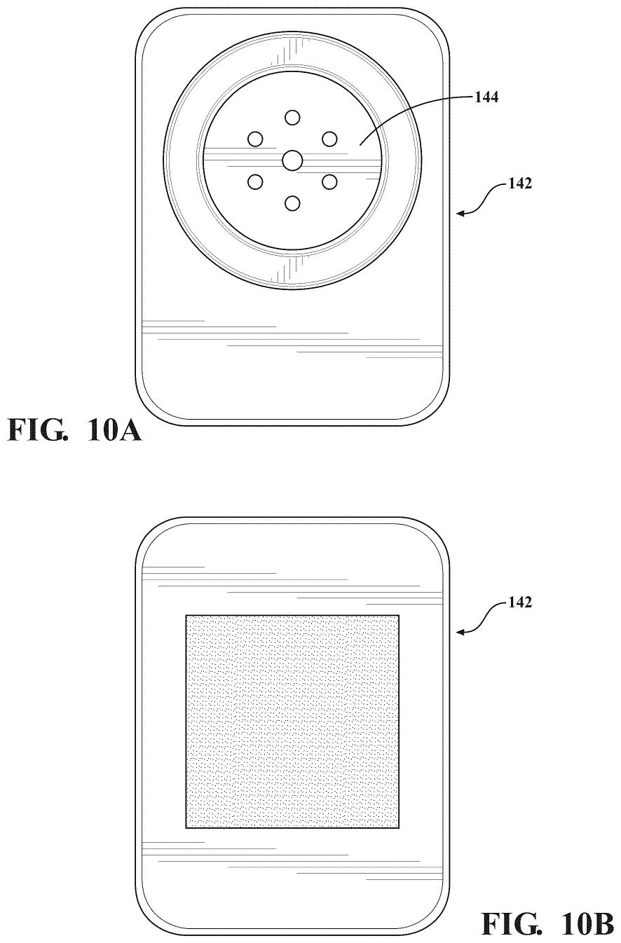

An algorithm stored on the PCB or other location can receive a signal from the embedded accelerometer if unusual movement is detected and cause a 130 dB siren (see FIGS. 10A and 10B) or other alarm (e.g. a horn of the vehicle or any other audible device incorporated with the vehicle) to sound if the catalytic converter 120 is tampered with or removed. In certain embodiments, the siren is located away from the device 100, for example in a secured compartment of the vehicle, to prevent undesirable manipulation of the device 100. Non-limiting examples of suitable compartments of the vehicle includes the engine compartment, the truck, the interior cabin, and the like. The siren may be in electrical communication with the device 100 via a wired connection or a wireless connection (e.g. Bluetooth).

It is contemplated that the algorithm could be programmed to determine when the vehicle is in motion and at rest to help prevent false positives. In addition, the algorithm should be able to differentiate between external shocks to the device while moving or even while ramping up or down where the earth gravity vector projection will change the captured three-dimensional acceleration. The algorithm could be programmed to analyze gravity vector projections, shock levels and directions, and shock signal shapes, duration and repetition, for example.

A microphone can be used to detect acoustical sounds of common power tools used when stealing catalytic converters and send a signal to the PCB if such sounds are detected to active the alarm and/or other components. In addition to the alarm, the PCB can transmit an alert to a remote server to create a notification on an app on a user's phone or other device for example, as well as activate the GPS thereby allowing for the device to be tracked with the catalytic converter.

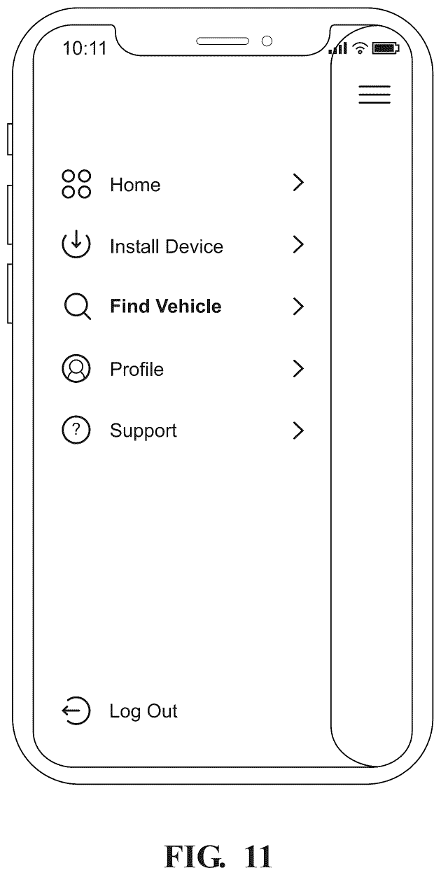

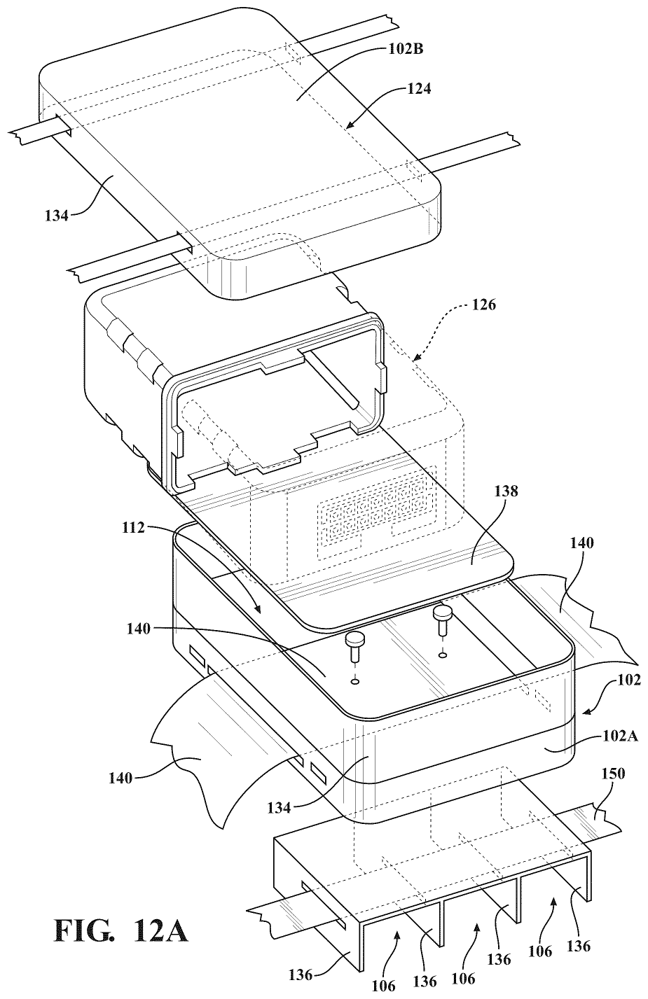

Thus, in such embodiments, the siren and GPS can be activated concurrently using acoustic recognition of a sawzall or similar tools as well as abnormal tilt of the catalytic converter (e.g., tilting the catalytic converter 60-degrees in any direction). Once activated, the app can track the catalytic converter in real time using GPS should it be removed from the vehicle's location. Important information such as catalytic converter serial numbers associated with the vehicle can be stored, which could be later used to prove ownership should a thief be caught with the stolen converter. It is contemplated that each tracking device can have a unique IMEI number that is associated with each specific catalytic converter serial number providing proof of ownership in a database.

Where remote communication is desired, such as with an app (e.g. FIG. 11), it is contemplated that the device could include a cellular modem or other transceiver to allow the device to connect to a remote server or other device. The transceiver could allow for the device to connect via a wireless network to the remote server. Because vehicles are often not parked in areas with strong Wi-Fi signals, the cellular modem would allow for continuous monitoring and tracking of the device, as needed. Remote communication of the device 100 may permit location tracking of the device 100, notifying the user of an attempted theft of the device 100, disarming of the device 100 (e.g. during service of the vehicle), and tracking the health of the catalytic converter 120 by monitoring the temperature of the catalytic converter 120. It is to be appreciated that a plurality of devices 100 can be tracked by an organization to monitor a certain subset of vehicles for defective catalytic converters 120. If desired, internal temperature and humidity sensors could be included to ensure the conditions within the cavity are within recommended ranges.

It is also contemplated that the device 100 can include a “peel and stick” cover.

In alternative embodiments, a device (not shown) includes a cable configured to transmit an electrical signal between at least one of a controller or a siren. The device may further include a shielding disposed around the cable. The cable and the shielding may extend along the exhaust system of a vehicle, including the catalytic converter, to deter theft of the catalytic converter and activate a siren when a theft is attempted. During an attempted theft, an attempt to cut through the exhaust system will result in cutting the wire thereby preventing communication of the electrical signal to the controller, siren, or both.

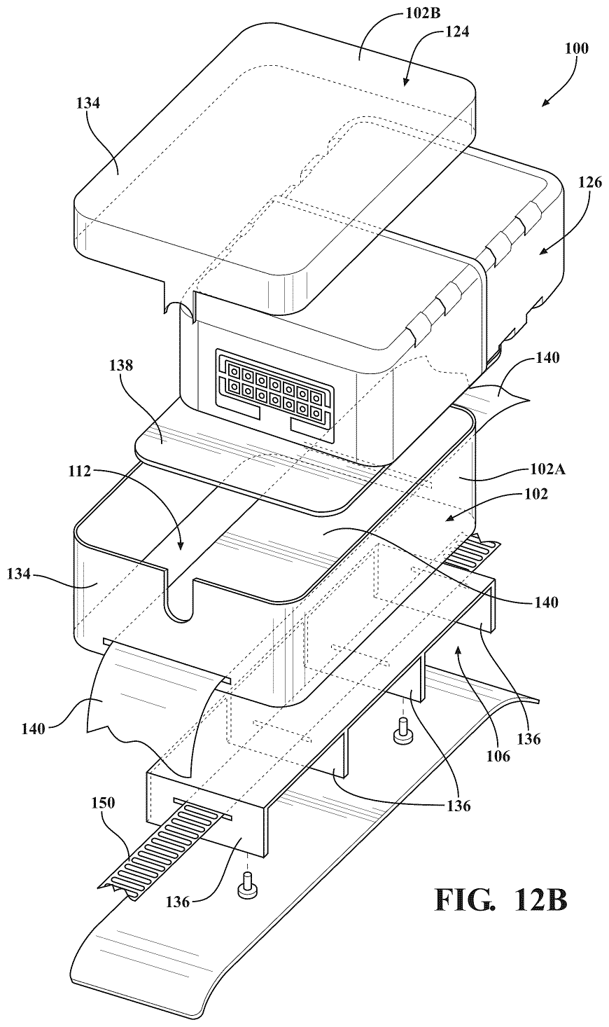

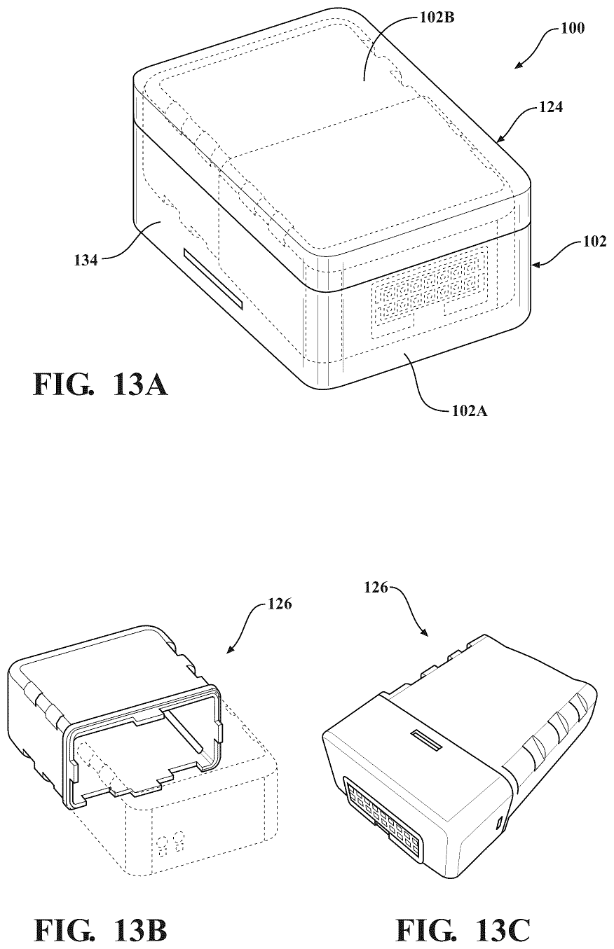

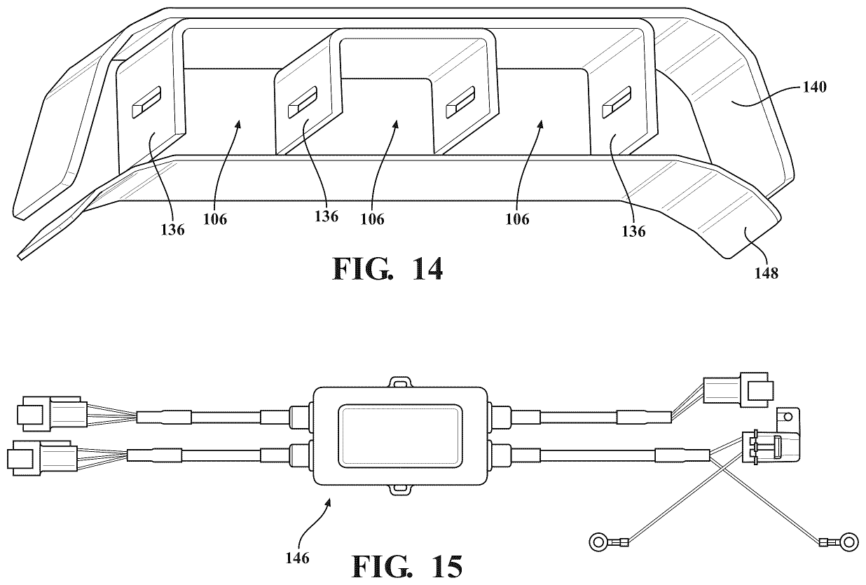

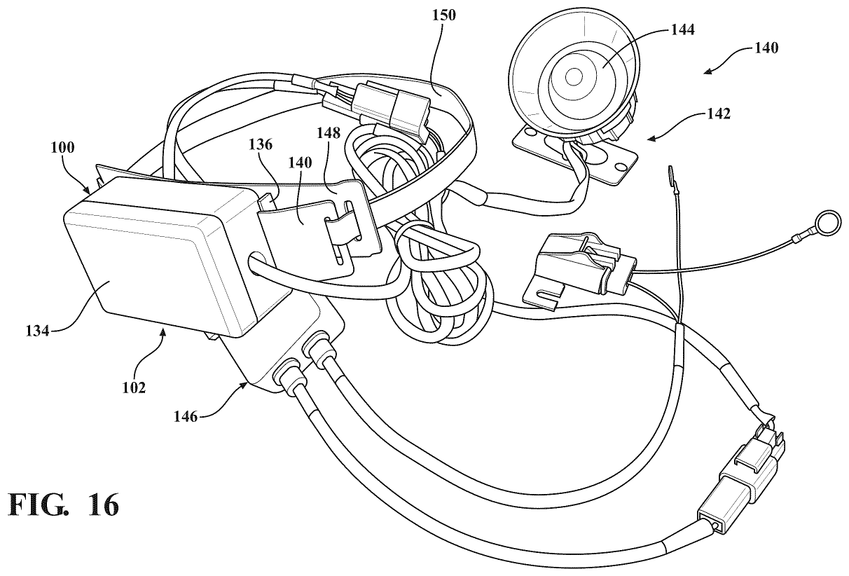

With reference to FIGS. 1-16, in various exemplary embodiment, a device 100 for prevention and recovery of a vehicle component 120 (e.g., a catalytic converter) is provided herein. The device 100 comprises a housing 102 having an exterior surface 134 and defining an interior cavity 112. The device 120 further comprises an electronic component 126 disposed within the interior cavity 112. The device 100 further comprises a plurality of spacers 136 extending from the exterior surface 134 and configured to be adjacent to the vehicle component 120. The plurality of spacers 136 defines a channel 106 configured to promote airflow between the device 100 and the vehicle component 120 thereby minimizing heat transfer between the device 100 and the vehicle component 120.

The inventors contemplate that the electronic component 126 comprises a computing device, a siren, an audio sensor, an accelerometer, a gyroscope, a cellular modem, a GPS locator, a battery, a wireless transceiver, or combinations thereof. In exemplary embodiments, the electronic component 126 comprises the computing device, the battery, the wireless transceiver, and the GPS locator. In these and other embodiments, the computing device is configured to cause the wireless transceiver to generate an alert signal when the device 100 is isolated from the external power. Further, in various embodiments, the computing device is configured to cause the GPS locator to generate a location signal when the device 100 is isolated from the external power. To this end, the battery is configured to energize the computing device, the wireless transceiver, and the GPS locator when the device 100 is isolated from the external power.

In some embodiments, the plurality of spacers 136 is adapted to be adjacent to a catalytic converter. For example, the plurality of spacers 136 may be adapted to conform to the shape of the catalytic converter to improve transmissivity of the heat generated by the catalytic converter to the plurality of spacers 136. The plurality of spacers 136 may be formed from any material suitable for transmitting heat, such as a thermal conductive material. Non-limiting examples of suitable materials include metals, such as aluminum, steel, or a combination thereof. The plurality of spacers 136 may be arranged as a heat sink with the heat sink having a length extending along the exterior surface 134, Each spacer 136 may have a height extending away from the exterior surface 134 and a width transverse to the height. Each spacer 136 has height to width ratio of at least 3:1.

In some embodiments, the housing 102 comprises a polymeric material and an insulative material such that the interior cavity 112 does not exceed a temperature of more than 200 degrees F., no more than 175 degrees F., or no more than 150 degrees when the device is attached to the vehicle component. The polymeric material may be thermoplastic. In certain embodiments, the polymeric material comprises a polyamide, such as Nylon 66 which is commercially available. The insulative material may comprise glass. In certain embodiments, the insulative material comprises glass in an amount of at least 1 wt. %, 5 wt. %, or 10 wt. % based on a total weight of the insulative material (e.g., 15 wt. %). The inventors have unexpectedly discovered that the polymeric material having a melting point of 500 degrees F. and combined with glass results in an insulative material that is heat resistant while maintaining workable using ultrasonic welding.

The housing 102 may comprise a first portion 102A and a second portion 102B that are ultrasonically welded together. The ultrasonic welding process may be operated at a frequency of from 20 Hz to 40 Hz with a downward pressure of from 30 to 100 psi (e.g., 70 psi). The housing 102 may have a thickness from 0.001 inch to 1 inch (e.g., 0.1 inch).

In various embodiments, the device 120 further comprises an insulative layer 138 disposed within the interior cavity 112 and disposed between the electronic component 126 and the housing 102 proximate to the plurality of spacers 136. The insulative layer 138 may comprise a silicate (e.g., vitreous silicate fiber) and a metal (e.g., aluminum or steel). The insulative layer 138 is commercially available from Heatshield Products under the tradename Heatshield Armor.

The device 120 may further comprise an insert 140 comprising a middle portion of the insert 140 disposed within the interior cavity 112 of the housing 102 and an exterior portion of the insert 140 extending through the exterior surface of the housing 102.

A system 140 for prevention and recovery of a vehicle component 120 of a vehicle is also provided herein. The system 140 comprises a device 100 comprising a GPS locator. The device 100 is configured to be fixedly coupled to the vehicle component 120. The system 140 further comprises a vehicle device 142 comprising a siren 144. The vehicle device 142 is configured to be coupled to the vehicle. The system 140 further comprises a communication cable 146 coupled to the device 100 and the vehicle device 142 for providing a communication signal between the device 100 and the vehicle device 142. The system 140 is configured to cause the GPS locator to generate a location signal when there is an interruption in the communication signal through the communication cable 146. The system 140 is configured to cause the siren 144 to activate when there is an interruption in the communication signal through the communication cable 146.

In various embodiments, the vehicle device 142 is configured to receive an electrical current from the vehicle and provide the electrical current as the signal to the device 100 through the communication cable 146. In these and other embodiments, the device 100 further comprises a battery for energizing the GPS locator when there is an interruption in the communication signal through the communication cable 146. The device 100 may further include a wireless transceiver. To this end, the system 140 is configured to cause the wireless transceiver to generate an alert signal when there is an interruption in the communication signal through the communication cable 146.

In exemplary embodiments, the device 100 further comprises the housing 102 having the exterior surface 134 and defining the interior cavity 112 with the GPS locator disposed within the interior cavity 112. The device 100 further comprises an insert 140 with a middle portion of the insert 140 disposed within the interior cavity of the housing and an exterior portion of the insert 140 extending through the exterior surface 134 of the housing 102. The device 100 further comprises the plurality of spacers 136 extending from the exterior surface 134 and configured to be adjacent to the vehicle component. The device 100 further comprises a bracket 148 disposed adjacent to the plurality of spacers 136 and opposite the insert. The device 100 further comprises a strap 150 configured to couple to the vehicle component and configured to extend through the insert 140, the plurality of spacers 136, and the bracket 148 to prevent removal of the device 100 from the vehicle component.

The strap 150 may comprises an adhesive configured to be disposed between the strap 150 and the vehicle component. The vehicle component may comprise a catalytic converter.

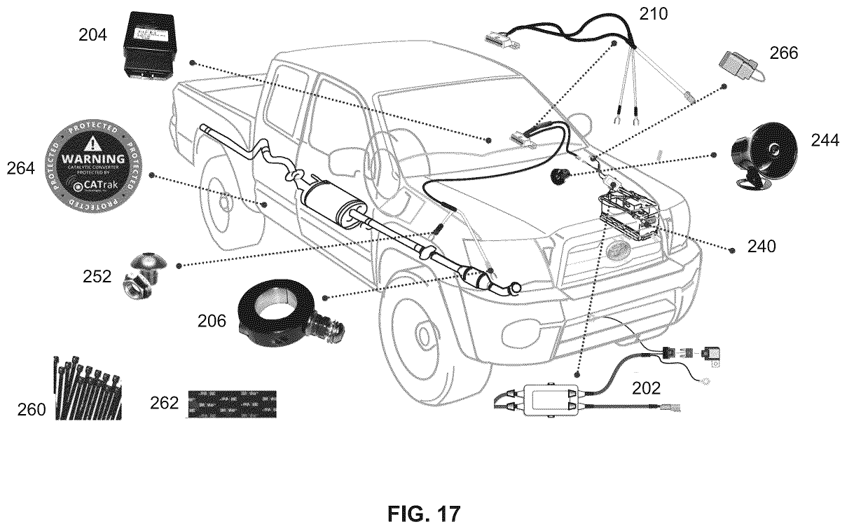

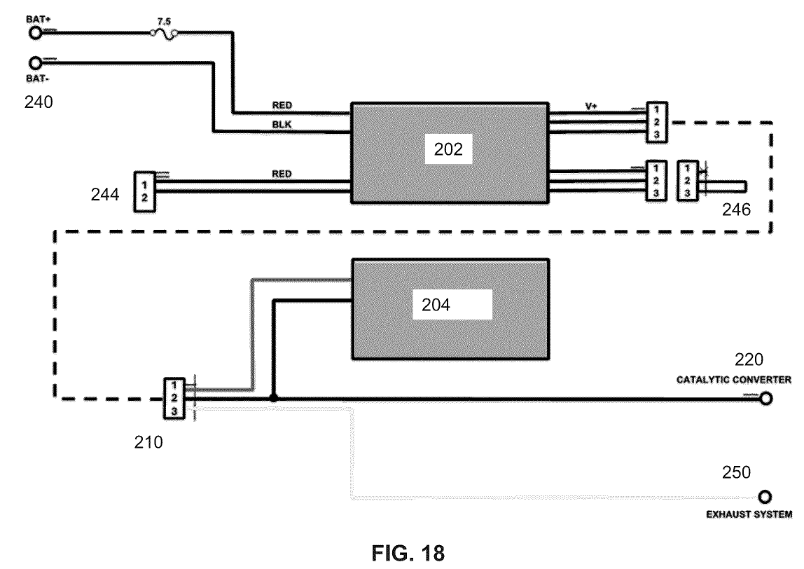

FIGS. 17-19 illustrate another embodiment of the inventive subject matter, preferably comprising a system for monitoring a status of a catalytic converter 220 or other item. The system may comprise various components including a monitoring device 202, a GPS locator 204 which may include a wireless transmitter or transceiver, a siren 244, and a sensor 206 for detecting tampering of a catalytic converter 220 or other item. A fuse 246 may be coupled to the monitoring device to protect components of the system against excessive current. Other components of the system can include a Deutch plug or connector 266, a decal 264 warning that vehicle comprises a security system, zip ties 260, double-sided tape 262, or other fasteners used to attach one or more components to different portions of the vehicle. For example, the monitoring device 202 may be tethered or otherwise mounted to an existing wiring harness of the vehicle.

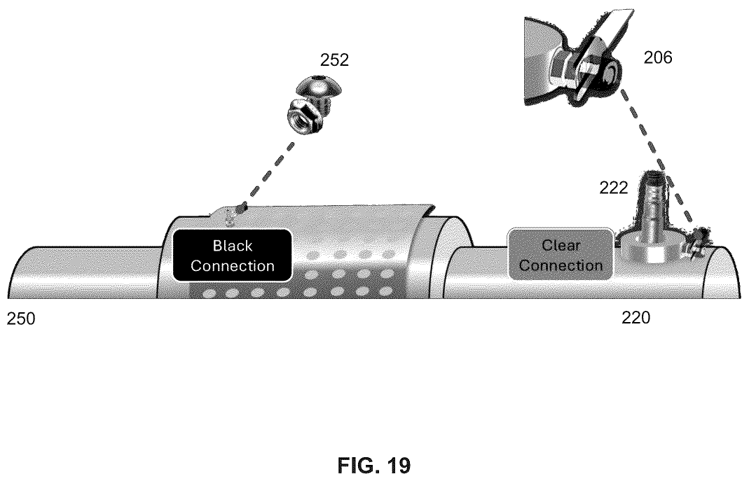

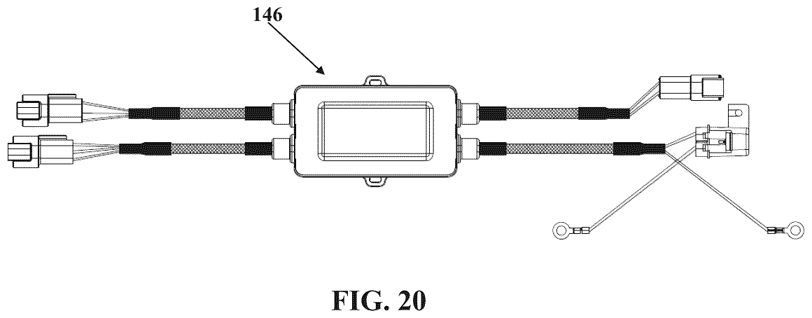

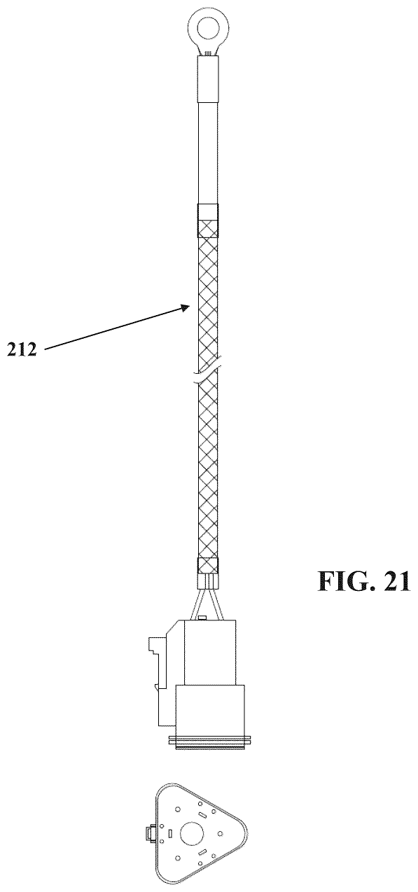

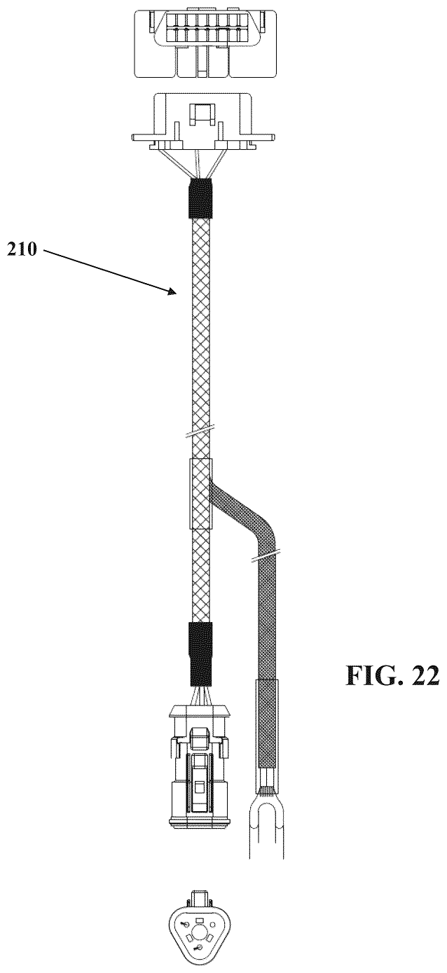

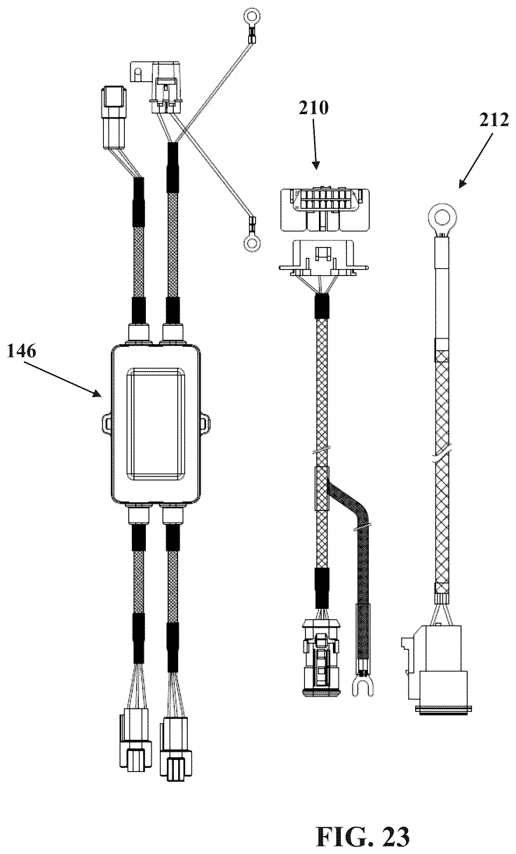

The monitoring device 202 may be communicatively coupled with the GPS locator 204 as shown in FIGS. 17 and 19. As discussed above, the GPS locator 204 may include a wireless transceiver or be communicatively coupled thereto. Contemplated wireless transceivers may include, for example, a cellular modem, a BLUETOOTH™ transceiver, a WIFI™ modem, or other wireless transceiver.

The monitoring device 202 may be connected to and powered by a vehicle battery 240 or other power source. The battery 240 may also be used to power other components of the system, such as those described herein.

The monitoring device 202 may also be communicatively coupled with siren 244 such that the monitoring device 202 can cause the siren 244 to activate.

The system can further include a harness 210 configured to connect the monitoring device 202 to the GPS locator 204, as well as to the exhaust pipe 250 and a sensor 206 monitoring the catalytic converter 220. Preferably, the harness is connected to hardware 252 coupled to the exhaust pipe 250. The system may additionally include a secondary harness 212. The sensor 206 may be connected to an oxygen sensor 222 disposed adjacent the catalytic converter 220.

As shown in FIG. 18, a circuit can comprise these components with the monitoring device 202 connected to the positive and negative terminals of the battery 240. In such circuit, the exhaust pipe 250 can act as a ground for the circuit allowing a return path for current in the circuit.

Preferably, the system is configured such that the monitoring device 202 can cause the GPS locator 204 to generate and transmit a location signal when power is interrupted to the monitoring device 202. This may occur, for example, if a thief cuts the exhaust pipe 250 to steal the catalytic converter 220 of a vehicle. When this occurs, the ground is removed from the circuit which can create an overcurrent condition and short the circuit. This can melt the fuse 246 creating an open circuit which stops the power to the monitoring device 202 from the car battery 240. When this occurs, the monitoring device 202 can cause the GPS locator 204 to generate and transmit the location signal. In such circumstance, the monitoring device 202 can cause the siren 244 to activate. It is contemplated that the monitoring device 202 and/or GPS locator 204 can comprise a separate battery to allow use of these devices when power from the vehicle's battery 240 is interrupted.

The monitoring device 202 acts as a cut detection module. The monitoring device 202 enables various components of the disclosed system to be spatially separated while maintaining communicative coupling between them. The term “communicatively coupled” may refer to the connection between two or more components such that the components may exchange information, signals, instructions, or data through any number of means, such as physical wiring, wireless transmission, optical and electrical signals, magnetic coupling, sound waves, or other forms of communication. This advantageously allows the components to be disposed throughout the vehicle and eliminates the need for sensitive electronics to be placed near the catalytic converter, for example, which can create excessive heat. This also allows for flexibility in placement, and allowing for easier maintenance, replacement of parts, or upgrades.

In preferred embodiments, the monitoring device 202 is communicatively coupled to sensor 206 that monitors for tampering or theft of the catalytic converter 220. When tampering is detected such as due to movement or disturbance of the sensor 206, the sensor 206 generates a signal which is transmitted to the monitoring device 202. Upon receipt of the signal, the monitoring device 202 may cause the GPS locator 204 to transmit a location signal and/or cause the siren 244 to activate

It is contemplated that the siren 244 may be an electrical or mechanical siren that has the ability to make a loud noise. If the system is integrated into a vehicle, the siren can be affixed to an existing stud or bracket in the engine bay that has a nut, or by removing and reaffixing an existing bolt, for example.

Such systems described herein have many uses to detect theft of an item, for example. In the examples where the system is disposed within a vehicle, the system may be configured to monitor for theft of a catalytic converter. Often, theft of a catalytic converter involves cutting or sawing through the exhaust pipe. When the exhaust pipe is cut or sawed, the circuit comprising the monitoring device 202 is broken and power source will be interrupted, thus causing the system to transmit a location signal and/or cause the siren to alarm.

In some embodiments, the GPS locator is configured to receive an electrical current from the power source. In such embodiments, the GPS locator may include a power input port or connector, such as a micro-USB, USB-C, or other connector, which allows the GPS locator to draw an electrical current from a power source such as a battery. Alternatively, a voltage regulation circuit may be included to adjust and stabilize incoming voltage from the power source to the required level for the GPS locator to operate safely. In still other alternative embodiments, the GPS locator may comprise a battery of its own, in which case the GPS locator's own battery may draw an electrical current from the power source for charging.

Throughout the above discussion, references may be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The discussion herein provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refers to at least one of something selected from the group consisting of A, B, C . . . And N, the text should be interpreted as requiring only one element from the group, not A plus N, or B plus N, etc.

What is claimed is:

1. A system for locating a stolen or missing item, comprising:
a monitoring device;
a GPS locator communicatively coupled to the monitoring device;
a wireless transceiver communicatively coupled to the monitoring device;
a power source connected to the monitoring device for providing power to one or more of the monitoring device and the GPS locator;
wherein the monitoring device the GPS locator to generate a location signal when there is an interruption in power from the power source to the monitoring device or the GPS locator; and
wherein the monitoring device is further configured to cause the wireless transceiver to transmit the location signal to a remote server when there is the interruption in power from the power source to the monitoring device or the GPS locator.

2. The system of claim 1, wherein, when there is the interruption in power from the power source to the monitoring device, the monitoring device causes (i) the GPS locator to generate the location signal and (ii) the wireless transceiver to transmit the location signal to the remote server.

3. The system of claim 1, wherein the wireless transceiver is disposed within the GPS locator.

4. The system of claim 1, wherein the wireless transceiver is disposed within the monitoring device.

5. The system of claim 1, wherein the monitoring device is further communicatively coupled to a sensor disposed on or adjacent to a catalytic converter, and wherein the sensor is configured to generate a signal when the sensor detects tampering with the catalytic converter, and wherein the monitoring device causes (i) the GPS locator to generate the location signal and (ii) the wireless transceiver to transmit the location signal to the remote server when the signal is received from the sensor.

6. The system of claim 1, wherein the monitoring device is communicatively coupled to a siren, and wherein the monitoring device causes the siren to activate an alarm when there is the interruption in power from the power source to the monitoring device.

7. The system of claim 1, wherein the GPS locator is configured to receive an electrical current from the power source.

8. The system of claim 1, wherein the monitoring device comprises a battery.

9. The system of claim 1, wherein the system is integrated into a motor vehicle, wherein the power source comprises a battery of the motor vehicle, and wherein the monitoring device is configured to monitor a status of a catalytic converter of the motor vehicle.

10. The system of claim 1, wherein the wireless transceiver comprises a cellular modem, a WIFI modem, or a Bluetooth transceiver.

11. A system for monitoring for tampering or theft of a vehicle component, comprising:
a monitoring device communicatively coupled with a GPS receiver, wherein the monitoring device is configured to connect to, and be powered by, a battery of a vehicle;
a harness configured to connect the monitoring device to (i) an exhaust pipe of the vehicle and (ii) a sensor configured to generate a signal if removed from its location;
wherein the monitoring device, battery, and GPS receiver form a circuit, with the exhaust pipe and sensor acting as a ground connection to create a return path for current in the circuit;
wherein, upon an interruption in power to the monitoring device, the monitoring device is configured to cause the GPS locator to generate a location signal.

12. The system of claim 11, wherein upon the interruption in power to the monitoring device, the monitoring device is configured to cause a wireless transceiver to transmit the location signal to a remote server.

13. The system of claim 12, wherein the wireless transceiver is disposed within the monitoring device or the GPS locator.

14. The system of claim 11, wherein the interruption in power to the monitoring device results from a break in the circuit.

15. The system of claim 14, wherein the break in the circuit occurs when the exhaust pipe is severed.

16. The system of claim 11, wherein the monitoring device or the GPS locator comprises a second battery.

17. The system of claim 11, wherein the monitoring device is further communicatively coupled to a siren, and wherein the monitoring device is configured to cause the siren to activate an alarm when there is the interruption in power to the monitoring device.

18. The system of claim 11, wherein the sensor is configured to monitor for tampering or theft of a catalytic converter.

19. The system of claim 18, wherein the monitoring device is communicatively coupled to the sensor, and wherein the monitoring device causes (i) the GPS locator to generate the location signal when the signal is received from the sensor.
